(19) United States
(12) Patent Application Publication
(10) Pub. No.: US 2008/0271551 A1
(43) Pub. Date: Nov. 6, 2008

(54) Drive Apparatus

(76) Inventor: Ohannes Meguerditchian, Glendale, CA (US)

Correspondence Address: ITALIA IP, 3500 WEST OLIVE AVE., SUITE 300, BURBANK, CA, 91505, US

(21) Appl. No.: 11/743,667

(22) Filed: May 2, 2007

(51) Int. Cl. F16H 37/00; B62M 1/04

(52) U.S. Cl. 74/37; 280/257; 280/261

(57) ABSTRACT

A drive apparatus for converting a substantially linear driving force to a rotary propulsive force, the apparatus including a power assembly for accepting a substantially linear drive force and converting said substantially linear drive force to a rotary propulsive force.

### BACKGROUND OF INVENTION

This application relates generally to a drive apparatus. More specifically, this application discloses a drive apparatus that converts a substantially linear driving force to a rotary propulsive force that may be used in a variety of applications such as to generate the propulsive force in a bicycle.

### SUMMARY

This application discloses a drive apparatus for converting a substantially linear driving force to a rotary propulsive force. The apparatus is of simple construction and can be used in a variety of applications including in standard bicycles, tricycles, reclining bicycles, personal watercraft such as paddle boats, scooters and any other similar transportation apparatus that uses a rotational force as a means to propel the transportation apparatus forward. The drive apparatus can also be uses in stationary exercise devises such at stationary bikes, stair climbers, and any devices that utilize a reciprocating substantially linear force as part of the exercise regimen.

In particular, this application discloses a drive apparatus for converting a substantially linear driving force to a rotary propulsive force, said apparatus comprising a power assembly means for accepting a substantially linear drive force and converting said substantially linear drive force to a rotary propulsive force.

This application also discloses a drive apparatus for converting a substantially linear drive force to a rotary propulsive force, said apparatus comprising a power assembly wherein the power assembly includes a pair of pedal brackets independently mounted to unidirectional clutch means upon a single power axle whereby a substantially linear force applied in only one direction to either of said pedal brackets produces a rotary propulsive force to a power sprocket fixably mounted to said power axle.

This application further discloses a drive apparatus for converting a substantially linear drive force to a rotary propulsive force, said apparatus comprising: a power assembly wherein the power assembly includes a pair of pedal brackets independently mounted to unidirectional clutch means upon a single power axle whereby a substantially linear force applied in only one direction to either of said pedal brackets produces a rotary propulsive force to a power sprocket fixably mounted to said power axle; a reciprocating assembly functionally linked to said pedal brackets comprising a pivot housing for pivotably attaching a pivot bracket thereto, and wherein the pivot bracket includes an attachment region at each end for functionally attaching the pivot bracket to said pedal brackets such that when one pedal bracket receives a substantially linear force in one direction, the other pedal bracket moves in the opposite direction; a drive assembly; and a power transference assembly for linking said power assembly to said drive assembly, thereby transferring said rotary propulsive force to said drive assembly, wherein the power transference assembly includes a transfer sprocket fixably attached to a transfer axle and wherein said power sprocket is functionally linked to said transfer sprocket by chain means such that when said power sprocket rotates the transfer sprocket rotates which in turn rotates the transfer axle fixably attached thereto, and wherein said drive assembly comprises a first and second drive sprocket functionally linked by a chain means, wherein the first drive sprocket is fixably attached to the one end of said transfer axle and the second drive sprocket is fixably attached to a drive axle such that when the transfer axle rotates the first and second drive sprocket rotate.

### BRIEF DESCRIPTION OF THE DRAWINGS

The drawings, when considered in connection with the following description, are presented for the purpose of facilitating an understanding of the subject matter sought to be protected.

FIG. 1 is left side plan view of the drive apparatus disclosed herein incorporated on a bicycle;

FIG. 2 is a right side plan view of the drive apparatus in FIG. 1;

FIG. 3 is a top view of the drive apparatus in FIG. 1;

FIG. 4 is a rear view of the drive apparatus in FIG. 1;

FIG. 5 is an enlarged, fragmentary, cross-sectional view along the line 5-5 in FIG. 4;

FIG. 6 is an enlarged, fragmentary, perspective view of the drive apparatus drive apparatus in FIG. 1 shown from a slightly different angle as shown if FIG. 2;

FIGS. 7A and 7B is an enlarged, fragmentary, cross-sectional view along the line 7-7 in FIG. 4 with the rear wheel removed; and

FIG. 8 is an enlarged, fragmentary, perspective view of the drive apparatus drive apparatus in FIG. 1 shown from a slightly different angle as shown if FIG. 2.

### DETAILED DESCRIPTION

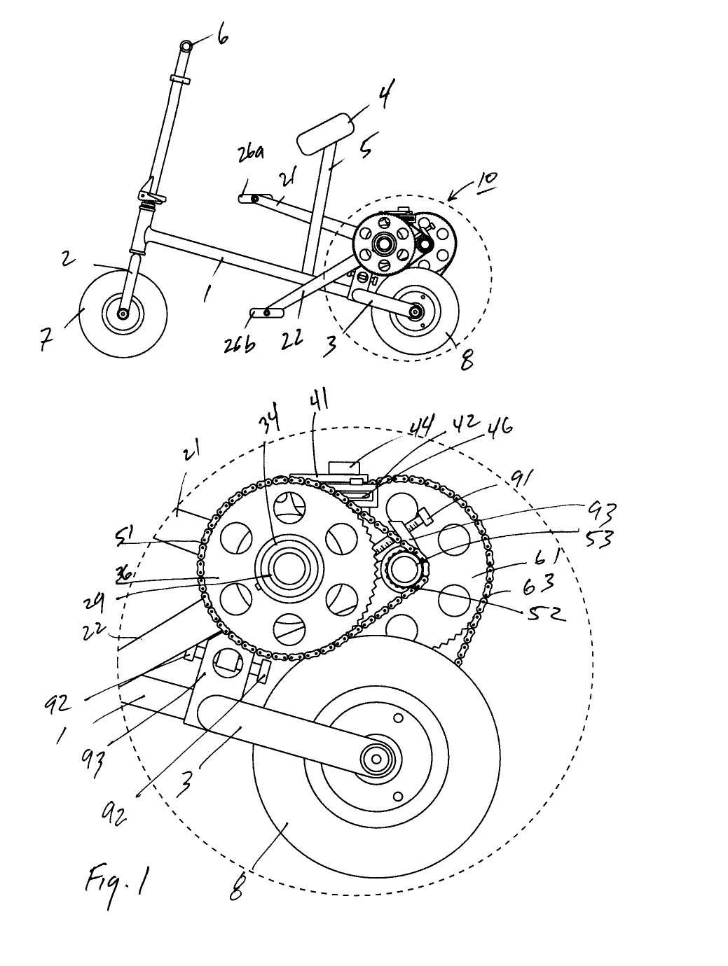

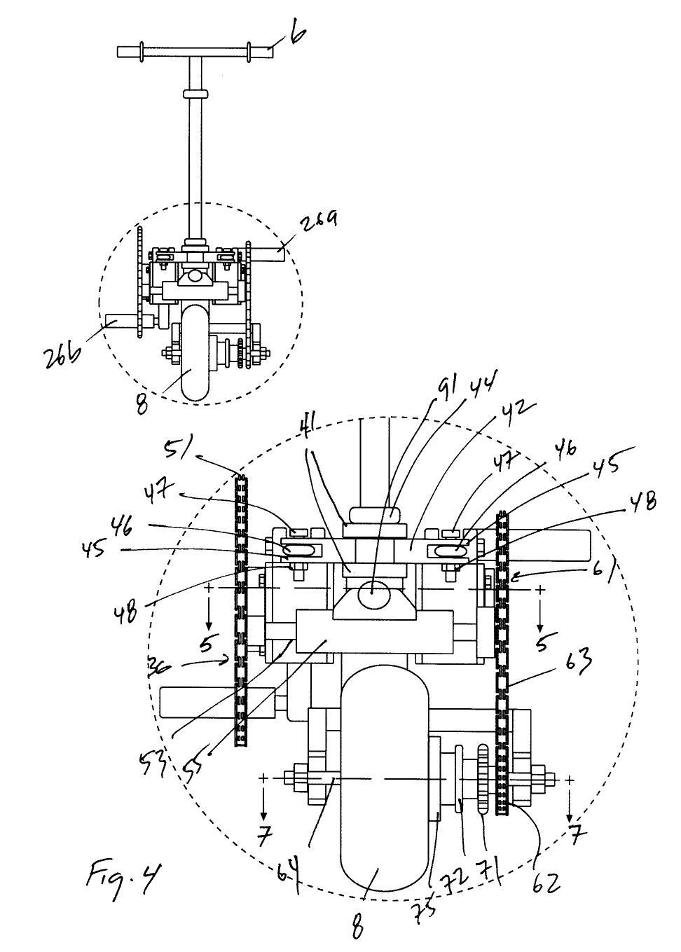

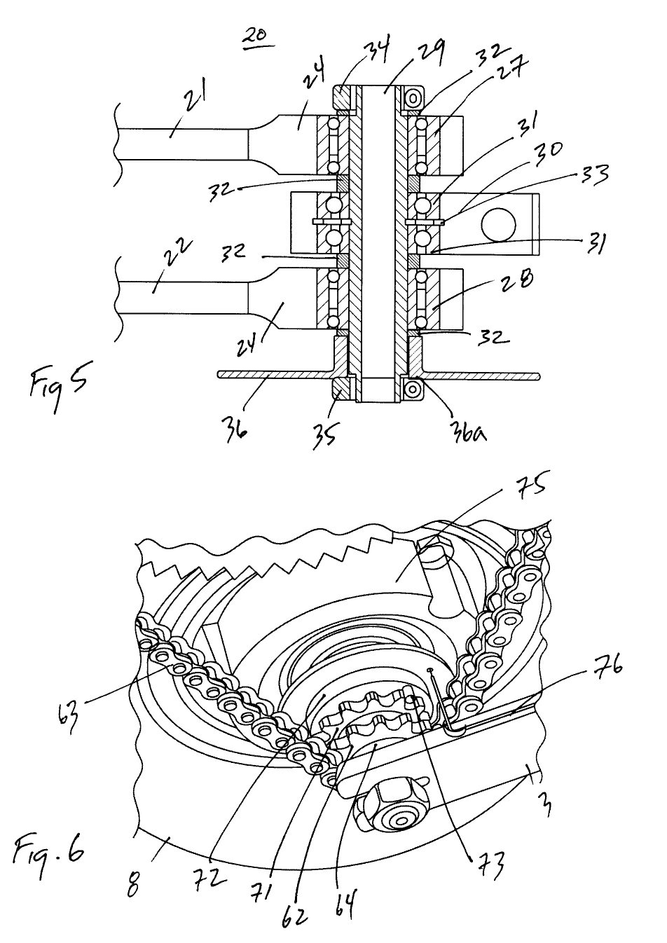

Referring to FIGS. 1-4, shown therein and generally designated by the reference character 10 is an embodiment of the drive apparatus 10 constructed in accordance with the following description. The drive apparatus 10 is shown incorporated in a bicycle, however, it should be appreciated that the drive apparatus may be incorporated in a scooter, a tricycle, a reclining bicycle or any other similar transportation device that utilizes a rider's “peddling” motion to propel the transportation device in a desired direction. Regardless of the nature of the transportation device, which are well known in the art, and shown for example purposes only, each is generally characterized by having a frame 1 that includes a front forks 2, rear forks 3, a seat 4, seat post 5, handle bars 6, and front 7 and rear 8 wheels. FIGS. 1-4.

Referring to FIGS. 1-4, the drive apparatus 10 includes a power assembly 20. The power assembly includes a first 21 and second pedal bracket 22. Each pedal bracket 21 and 22 includes a pedal attachment region 23 for attachment of pedals 26a and 26b, a power axel attachment region 24, and reciprocating attachment region 25 for attachment to a reciprocating assembly. See FIG. 8. The pedal brackets 21 and 22 are mounted at the power axel attachment region 24 on internal unidirectional clutches 27 and 28 which are in turn mounted on the power axel 29. See FIG. 5. A bearing housing 30 is located between each pedal bracket 21 and more specifically between the power axle attachment regions 24. The bearing housing includes bearings 31 that allow the power axle 29 to rotate there through. As shown, spacer washers 32 are provided to allow the pedal brackets to freely rotate without coming in contact with the bearing housing 30. Further, the bearing housing is shown to have two bearings separated by a divider washer 33; however, it should be appreciated that a single bearing without a divider washer would also work. Additional spacer washers 32 are provided to separate the first pedal bracket 21 from the locking cap 34 and to separate the second pedal bracket 22 from a power sprocket 36. The locking cap 34 is secured to the outer portion 21a of the first pedal bracket 21 and is provided to retain the first pedal bracket 21 upon the power axle 29. A second locking cap 35 is secured to the power axle 29, adjacent to the outer portion 36a of the power sprocket 36 to retain the power sprocket 36 and the second pedal bracket 22 upon the power axle 29. Therefore as disclosed, when either the first 21 or second pedal bracket 22 is pushed in a downward direction when receiving a substantially linear force, the respective unidirectional clutches 27 and 28 engage and enable the power axle 29 to turn in the proper direction (clockwise) which in turn causes the power sprocket 36, which is fixedly attached to the power axle 29 to rotate as well thereby creating a rotary propulsive force. Likewise, when either the first 21 or second pedal bracket 22 is pushed in an upward direction, the respective unidirectional clutches 27 and 28 disengage the power axle 29 and therefore the power axle 29 and the power sprocket 36 is not rotated.

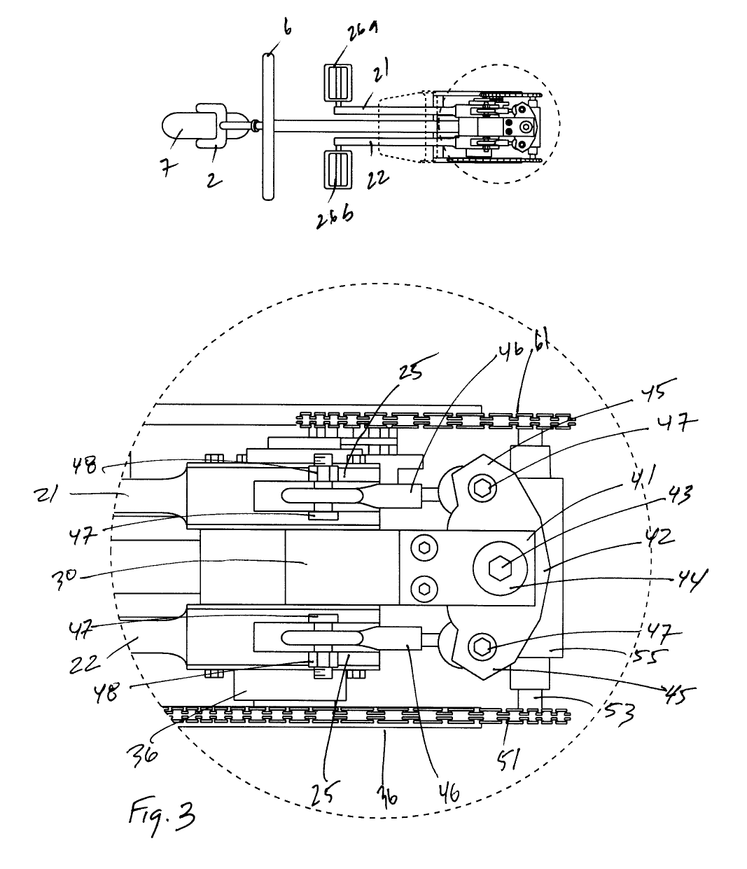

Referring now to FIGS. 3, 4 and 8, a reciprocating assembly 40 is included with the drive apparatus 10. The reciprocating assembly 40 provides for the event whereby when either the first 21 or second 22 pedal bracket is pushed in a downward direction, the other automatically rises. The reciprocating assembly includes a pivot housing 41 that extends from the bearing housing 30. The pivot housing 41 includes a pivot bracket 42 that has a substantially “T” shape so that it can teeter about an axis 43. As shown, the axis 43 is an axis bolt 44 that extends through the pivot housing 41 and the pivot bracket 42. The axis bolt 44 functionally engages a pivot bearing 43a fixedly attached to the pivot bracket 42 such the pivot bracket is able to teeter back and forth about the axis bolt 44. The pivot bracket further comprises a pair of ball link attachment regions 45 whereby a pair ball links 46 are used to attach the pedal brackets 21 and 22 at the reciprocating attachment region 25 of each pedal bracket. The ball links 46 are attached to the ball link attachment regions 45 and the reciprocating attachment regions 25 through the use of bolt 47 and nut 48 assemblies as is common in the art. The ball links 46 maybe adjustable so that the distance the pedal brackets 21 and 22 travel can be adjusted to suit a given user. As just described, the reciprocating assembly 40 forms a closed loop such that when first pedal bracket 21 is pushed downward by the rider, the second pedal bracket will automatically rise and vice versa. Likewise, when first pedal bracket 21 is pulled upward, the second pedal bracket 22 will automatically go down and vice versa. And as described above, this reciprocating motion of the pedal brackets 21 and 22 causes the power axle to rotate in a forward or clockwise direction when either of the brackets is pushed downward by the rider. This in turn causes the power sprocket 36, which is fixedly attached to the power axle 29, to rotate in the forward direction.

The drive apparatus 10 also includes a power transference assembly 50 mechanically connected to the power assembly 20 and mechanically coupled to a drive assembly 60, thereby mechanically connecting the power assembly 20 to the drive assembly 60. The power transference assembly 50 is mechanically linked to the power assembly 20 by a power transference chain 51. The power transference chain 51 links the power sprocket 36 to a transfer sprocket 52 such that when the power sprocket rotates 36, the transfer sprocket 52 also rotates. The transfer sprocket 52 is then functionally linked to a transfer axle 53 at one end 54, wherein the transfer axle proceeds with in a housing 55 and then is functionally linked to the drive assembly 60 at the opposite end 56, more specifically to the first drive sprocket 61. Again, such that when the transfer sprocket 52 is rotated in the forward direction, the functionally linked first drive sprocket 61 is also rotated in the forward direction. The drive assembly 60 includes the first drive sprocket 61 which is functionally linked to a second drive sprocket 62 by a drive chain 63 such that when the first drive sprocket 61 rotates in the forward direction, the second drive sprocket 62 rotates in the forward direction. The second drive sprocket 62 is rotationally mounted on the drive axle 64 such that when the second drive sprocket 62 is rotated the functionally mounted rear wheel 8 attached thereto is rotated in a forward direction.

During operation of the drive apparatus 10 the following events take place in converting a substantially linear driving force to a rotary propulsive force. Referring to FIGS. 1, 2 and 8, the drive apparatus 10 is shown incorporated in a bicycle where a rider places his or her feet on the pedals 26a and 26b attached respectively to the pedal brackets 21 and 22. The pedal brackets 21 and 22 act as a lever arms about a pivot point 11 upon the power axle 29 such that when the rider pushes down on the pedal 26a, the foot travels downward in a substantially linear direction, in this example, a substantially vertical direction. As the pedals 26a and 26b reciprocate up and down, attached to their respective pedal brackets 21 and 22, the unidirectional clutches 27 and 28 mounted within the respective pedal brackets 21 and 22, cause the power axle 29 the clutches are mounted upon to rotate in a forward direction (clockwise). Thus, when the first pedal bracket 21 and the attached pedal 26a is pushed down, the unidirectional clutch 27 engages the power axle 29 and rotates it in a forward direction. At the same time, the second pedal bracket 22 and attached pedal 26b is pushed up through attachment to the reciprocating assembly 40, which causes the second unidirectional clutch 28 to rotate counter-clockwise, thereby disengaging the unidirectional clutch 39 from the power axle 29. Consequently, there is always a rotational propulsive force being applied to the power axle 29 by either one of the pedal brackets 21 and 22 in response to a substantially linear force being applied to them and the respective unidirectional clutches 27 and 28. In this way the power sprocket 36 is turned and the propulsive force is created which then is transferred to and leads to the activation of the power transference assembly 50 and the drive assembly 60 as described above.

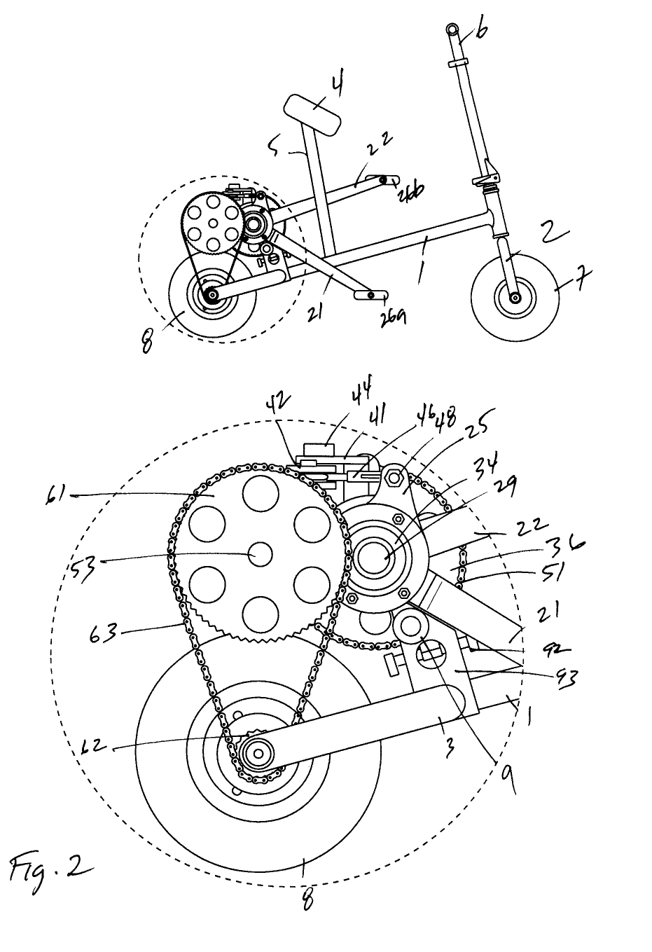

The range of upward and downward motion of each pedal bracket 21 and 22 can be as much as 180°, however a range of approximately 40° to approximately 60° is preferred, and a range of approximately 45° to approximately 55° is particularly preferred. The downward movement of the pedal brackets 21 and 22 may be terminated by a pair of pedal bracket stops 9 which are mounted on the frame 1. See FIG. 2. The pedal stops 9 may be rubber coated so at to provide a resilient and cushioned surface for the pedal brackets 21 and 22 to rebound off of. The pedal stops 9 may also have a hydraulic or gas-filled shock absorber nature to them to better absorb the downward force of the pedal brackets 21 and 22 and allow for a more efficient rebound of the pedal brackets 21 and 22 off the pedal stops 9 so that the impact on the rider is minimized.

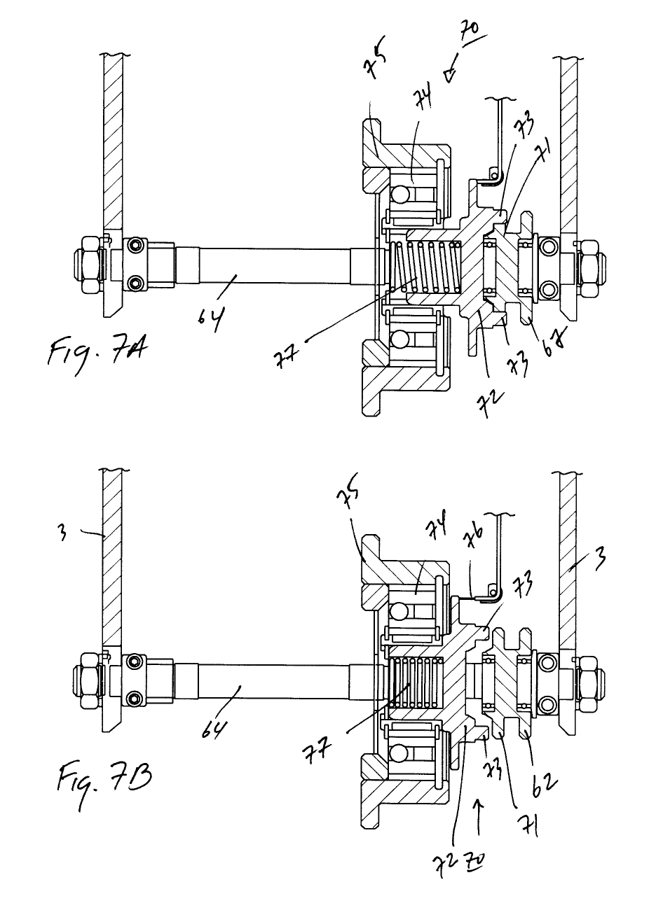

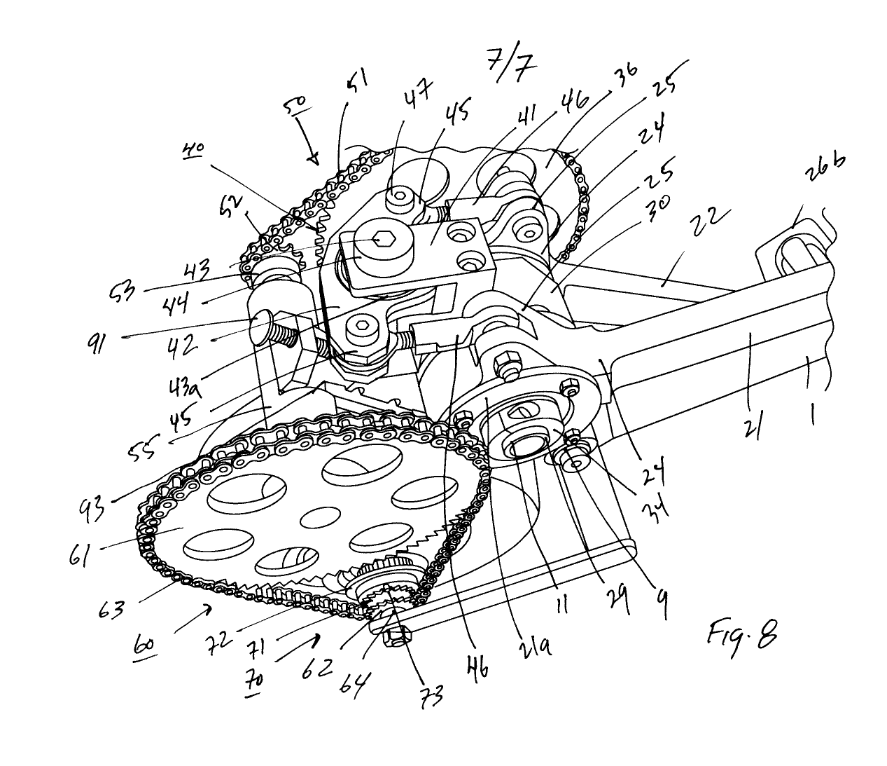

Referring to FIGS. 7A, 7B and 8, the drive apparatus 10 may include a clutch assembly 70. The clutch assembly allows the rear wheel 8 to rotate in the reverse direction, for example when you need to back-up the bike. The clutch assembly includes a clutch sprocket 71 functionally linked to the second drive sprocket 62 (such that both sprockets rotate as one), a clutch plate 72 functionally engages the clutch sprocket 71 by a pair of prongs 73 mounted upon its surface. In this engaged orientation, as shown in FIG. 7A, the rotational force of the clutch sprocket 71 rotates the clutch plate 72 and the unidirectional clutch 74 mounted within the wheel hub 75 allows the wheel hub to rotate and the bike is propelled forward. The disengaged orientation, as shown in FIG. 7B, is created by a lever arm 76 that creates a force upon the surface of the clutch plate 72, which cause a spring 77 mounted on the opposite surface of the clutch plate to compress and thereby disengage the prongs 73 of the clutch plate 72 from the clutch sprocket 71 and the rear wheel 8 is free to rotate in the reverse or forward direction. The spring 77 acts to maintain a constant force upon the clutch plate 72 so that it remains engaged to the clutch sprocket 71 during forward operation.

Finally, the drive apparatus 10 may include an adjustment assembly 90, that includes an upper adjustment bolt 91 and a pair of lower adjustment screws 92 which allows the angle and position of the apparatus to be adjusted and thereby maintain tension in the power transference chain 51 and the drive chain 63. See FIG. 1. The bolts and screws act by creating a force upon the drive apparatus 10 which resides upon a track 93 located about a portion of the frame 1. For example, when the upper bolt 91 is tightened, the drive apparatus is lowered within the track 91. Likewise, when one of the lower screws 92 is loosened and the other tightened, the angle of the drive apparatus within the tracks 93 can be adjusted.

While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements. For example instead of the standard link chain common in the art for engaging the teeth of a sprocket as described above, it should be understood that the disclosure includes the use of timing belts or other cables that would be able to similarly engage the teeth of a sprocket.

What is claimed is:

1. A drive apparatus for converting a substantially linear driving force to a rotary propulsive force, said apparatus comprising: a power assembly means for accepting a substantially linear drive force and converting said substantially linear drive force to a rotary propulsive force.

2. The apparatus of claim 1 further comprising reciprocating means.

3. The apparatus of claim 2 wherein the power assembly means is functionally linked to a power transference assembly means for transferring said rotary propulsive force to a drive assembly means.

4. The apparatus of claim 3 further comprising clutch assembly means.

5. The apparatus of claim 1 wherein the power assembly means is functionally linked to a power transference assembly means that transfers said rotary propulsive force to a drive assembly means.

6. A drive apparatus for converting a substantially linear drive force to a rotary propulsive force, said apparatus comprising: a power assembly wherein the power assembly includes a pair of pedal brackets independently mounted to unidirectional clutch means upon a single power axle whereby a substantially linear force applied in only one direction to either of said pedal brackets produces a rotary propulsive force to a power sprocket fixably mounted to said power axle.

7. The drive apparatus of claim 6 wherein said pedal brackets are functionally linked to reciprocating assembly means such that when one pedal bracket receives a substantially linear force in one direction, the other pedal bracket moves in the opposite direction.

8. The apparatus of claim 7 further comprising a power transference assembly for linking said power assembly to a drive assembly, thereby transferring said rotary propulsive force to said drive assembly.

9. The apparatus of claim 8 wherein the power transference assembly includes a transfer sprocket fixably attached to a transfer axle and wherein said power sprocket is functionally linked to said transfer sprocket by chain means such that when said power sprocket rotates the transfer sprocket rotates which in turn rotates the transfer axle fixably attached thereto.

10. The apparatus of claim 9 wherein the drive assembly includes a first and second drive sprocket functionally linked by a chain means, wherein the first drive sprocket is fixably attached to the opposite end of said transfer axle and the second drive sprocket is fixably attached to a drive axle such that when the transfer axle rotates the first and second drive sprocket rotate.

11. The apparatus of claim 10 further comprising a clutch assembly means for allowing rear wheel mounted thereto to rotate in the reverse direction.

12. The apparatus of claim 11 wherein the clutch assembly means includes a clutch sprocket functionally linked to said second drive sprocket such that both the clutch sprocket the second drive sprocket rotate as one, a clutch plate reversibly engaged to the clutch sprocket such that when said clutch plate is engaged to said clutch sprocket the rear wheel does not rotate in the reverse direction and when said clutch plate is disengaged the rear wheel is able to rotate in the reverse direction.

13. The apparatus of claim 6 further comprising a power transference assembly for linking said power assembly to a drive assembly, thereby transferring said rotary propulsive force to said drive assembly.

14. The apparatus of claim 13 wherein the power transference assembly includes a transfer sprocket fixably attached to a transfer axle and wherein said power sprocket is functionally linked to said transfer sprocket by chain means such that when said power sprocket rotates the transfer sprocket rotates which in turn rotates the transfer axle fixably attached thereto.

15. The apparatus of claim 14 wherein the drive assembly includes a first and second drive sprocket functionally linked by a chain means, wherein the first drive sprocket is fixably attached to the opposite end of said transfer axle and the second drive sprocket is fixably attached to a drive axle such that when the transfer axle rotates the first and second drive sprocket rotate.

16. The apparatus of claim 15 wherein the reciprocating assembly means comprises a pivot housing for pivotably attaching a pivot bracket thereto, and wherein the pivot bracket includes an attachment region at each end for functionally attaching the pivot bracket to said pedal brackets.

17. The apparatus of claim 7 wherein the reciprocating assembly means comprises a pivot housing for pivotably attaching a pivot bracket thereto, and wherein the pivot bracket includes an attachment region at each end for functionally attaching the pivot bracket to said pedal brackets.

18. A drive apparatus for converting a substantially linear drive force to a rotary propulsive force, said apparatus comprising:
a power assembly wherein the power assembly includes a pair of pedal brackets independently mounted to unidirectional clutch means upon a single power axle whereby a substantially linear force applied in only one direction to either of said pedal brackets produces a rotary propulsive force to a power sprocket fixably mounted to said power axle;
a reciprocating assembly functionally linked to said pedal brackets comprising a pivot housing for pivotably attaching a pivot bracket thereto, and wherein the pivot bracket includes an attachment region at each end for functionally attaching the pivot bracket to said pedal brackets such that when one pedal bracket receives a substantially linear force in one direction, the other pedal bracket moves in the opposite direction;
a drive assembly; and
a power transference assembly for linking said power assembly to said drive assembly, thereby transferring said rotary propulsive force to said drive assembly, wherein the power transference assembly includes a transfer sprocket fixably attached to a transfer axle and wherein said power sprocket is functionally linked to said transfer sprocket by chain means such that when said power sprocket rotates the transfer sprocket rotates which in turn rotates the transfer axle fixably attached thereto, and wherein said drive assembly comprises a first and second drive sprocket functionally linked by a chain means, wherein the first drive sprocket is fixably attached to the one end of said transfer axle and the second drive sprocket is fixably attached to a drive axle such that when the transfer axle rotates the first and second drive sprocket rotate.

19. The apparatus of claim 18 further comprising a clutch assembly means for allowing a rear wheel functionally mounted thereto to rotate in the reverse direction.

20. The apparatus of claim 19 wherein the clutch assembly means includes a clutch sprocket functionally linked to said second drive sprocket such that both the clutch sprocket the second drive sprocket rotate as one, a clutch plate reversibly engaged to the clutch sprocket such that when said clutch plate is engaged to said clutch sprocket the rear wheel does not rotate in the reverse direction and when said clutch plate is disengaged said rear wheel is able to rotate in the reverse direction.
